(19) United States
(12) Patent Application Publication
(10) Pub. No.: US 2019/0012687 A1
(43) Pub. Date: Jan. 10, 2019

(54) BID-PRICE DETERMINATION APPARATUS, BID-PRICE DETERMINATION METHOD, AND NON-TRANSITORY COMPUTER READABLE MEDIUM

(71) Applicant: KABUSHIKI KAISHA TOSHIBA, Minato-ku (JP)

(72) Inventors: Yusuke ENDOH, Kawasaki (JP); Mitsuru KAKIMOTO, Kawasaki (JP); Yoshiaki SHIGA, Kawasaki (JP); Hiromasa SHIN, Yokohama (JP); Takahiro YAMADA, Yokohama (JP); lchiro TOYOSHIMA, Toshima (JP); Yoshio KIYOSHIMA, Yokohama (JP); Tatsuo SATO, Fuchu (JP)

(73) Assignee: KABUSHIKI KAISHA TOSHIBA, Minato-ku (JP)

(21) Appl. No.: 15/911,981

(22) Filed: Mar. 5, 2018

(30) Foreign Application Priority Data
Jul. 5, 2017 (JP) 2017-132203

(51) Int. Cl. G06Q 30/02; G06Q 30/08; G06Q 50/06

(52) U.S. Cl. CPC G06Q 30/0206; G06Q 50/06; G06Q 30/08

(57) ABSTRACT

A bid-price determination apparatus includes an acquirer, an extractor, a predictor, a determiner, and an output device. The acquirer acquires a price history of a product before a current time in an electric power continuous session. The extractor extracts, from the acquired price history, a first feature quantity which is a feature quantity of the price history of the product. The predictor predicts, based on the extracted first feature quantity, a second feature quantity which is a feature quantity of price changes of the product after the current time. The determiner determines, based on the predicted second feature quantity, a transaction standard value which is a standard for a transaction of the product after the current time. The output device outputs the determined transaction standard value.

### CROSS REFERENCE TO RELATED APPLICATIONS

This application is based upon and claims the benefit of priority from Japanese Patent Application No. 2017-132203, filed on Jul. 5, 2017; the entire contents of which are incorporated herein by reference.

### FIELD

Embodiments described herein relate to bid-price determination apparatus, bid-price determination method, and non-transitory computer readable medium.

### BACKGROUND

In a forward market, electric power is conclusively sold and procured, and can be sold and bought from 17:00 on the previous day until one hour before the actual delivery of the electric power in Japan. In the forward market, electric power is sold and bought in a continuous session. In view of the fact that a power spot market, which is a conventional manner, is a single price auction, in order to perform algorithmic trading in the electric power continuous session, an algorithm different from an electric power transaction in the spot market is required. It is difficult to accumulate large electric power to be traded unlike financial products such as stocks, and the absolute amount also varies with the date and time. For this reason, it is difficult to create a portfolio unlike financial products in the case of handling only electric power products, and the necessity of efficient algorithmic trading is increasing.

In order to solve this problem, a technique for predicting price changes in a continuous session and a conventional technique for preparing a draft of a power transaction price by simulating a previous-day spot market and a real-time market have been devised. However, the technology for predicting price changes needs large-scale simulation and can take time too long. In addition, the technology for preparing a draft of a power transaction price is used for a relative transaction, and cannot be used as it is for a continuous session.

### BRIEF DESCRIPTION OF THE DRAWINGS

FIG. 1 is a block diagram showing functions of a bid-price determination apparatus according to an embodiment;

FIG. 2 is a diagram showing products and transaction periods in a continuous session;

FIG. 3 is a flowchart showing processing of a bid-price determination apparatus according to an embodiment;

FIG. 4 is a diagram showing a relation between a price history and bidding according to an embodiment;

FIG. 5 is a graph showing an example of a price history according to an embodiment;

FIG. 6 is a graph showing an example of bidding according to an embodiment;

FIG. 7 is a block diagram showing functions of another example of the bid-price determination apparatus;

FIG. 8 is a flowchart showing processing of another example of the bid-price determination apparatus; and

FIG. 9 is a block diagram showing functions of still another example of the bid-price determination apparatus.

### DETAILED DESCRIPTION

According to one embodiment, a bid-price determination apparatus includes an acquirer, an extractor, a predictor, a determiner, and an output device. The acquirer acquires a price history of a product before a current time in an electric power continuous session. The extractor extracts, from the acquired price history, a first feature quantity which is a feature quantity of the price history of the product. The predictor predicts, based on the extracted first feature quantity, a second feature quantity which is a feature quantity of price changes of the product after the current time. The determiner determines, based on the predicted second feature quantity, a transaction standard value which is a standard for a transaction of the product after the current time. The output device outputs the determined transaction standard value.

Hereinafter, an embodiment will be described in detail with reference to the drawings.

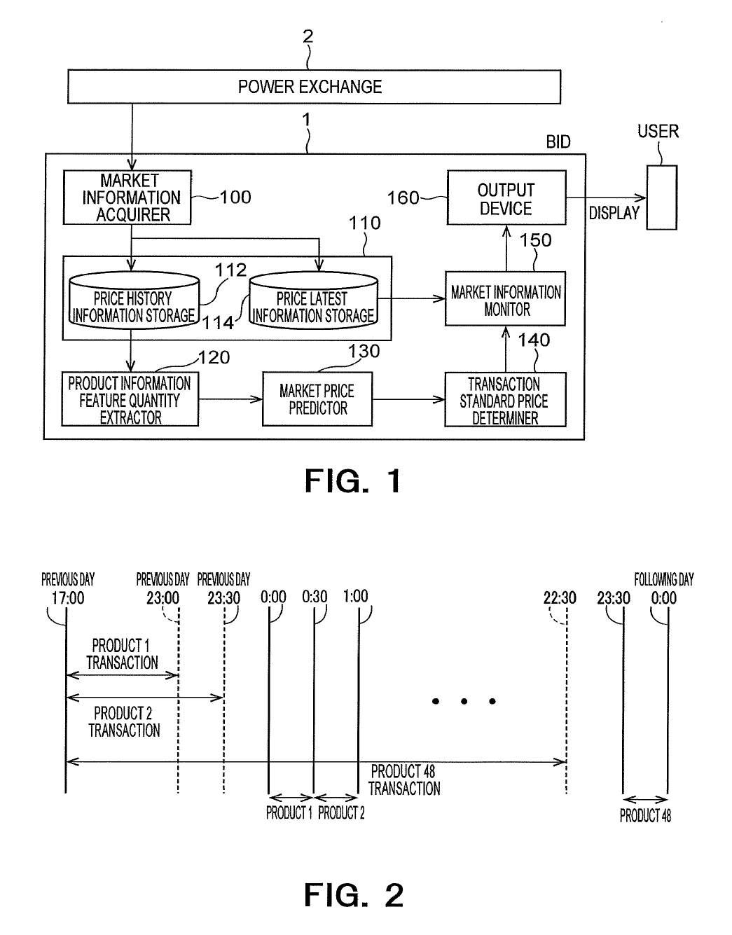

FIG. 1 is an example of a block diagram showing functions of a bid-price determination apparatus 1 according to the present embodiment. The bid-price determination apparatus 1 includes a market information acquirer 100, a market information storage 110, a product information feature quantity extractor 120, a market price predictor 130, a transaction standard price determiner 140, a market information monitor 150, and an output device 160. The bid-price determination apparatus 1 has a function for acquiring various data from a power exchange 2 and algorithmic trading to the power exchange 2, or a function for presenting, to a user, a standard price to be automatically bid.

The bid-price determination apparatus 1 determines a transaction price of each of a plurality of products sold and bought at the power exchange 2. The products sold and bought at the power exchange 2 will be described. FIG. 2 is a diagram showing products traded at the power exchange 2 in a day.

The products are electric power delivered every 30 minutes obtained by dividing 24 hours from 0:00 to 24:00 by 30 minutes. That is, for example, when the electric power delivered from 0:00 to 0:30 is referred to as a product 1, the electric power delivered from 0:30 to 1:00 is referred to as a product 2, . . . , and the electric power delivered from 23:30 to 24:00 (0:00 on the following day) is referred to as a product 48.

Note that, the period from 17:00 on the previous day to 17:00 on the appointed day is the standard in Japan, and the applicable range of the present embodiment is not limited to this, and an arbitrary time may be set as a start time based on the laws, standards, and the like in each country. In addition, the start time and the end time of a transaction can be similarly changed as appropriate based on the manners in each country.

The products are traded (sold and bought) in a continuous session from 17:00 on the previous day until one hour before the time when delivery of each product starts. That is, for example, the product 1 can be traded between 17:00 on the previous day and 23:00 on the previous day, and the product 2 can be traded between 17:00 on the previous day and 23:30 on the previous day. Similarly, the product 48 can be traded between 17:00 on the previous day and 22:30 on the appointed day. In this manner, each product has a separate transaction period, and is traded within a predetermined period.

Hereinafter, in the description of the specification, the words related to dates such as the previous day, the appointed day, and the following day, are used setting the consumption (demand and supply) time of electric power which is a product as a reference (the appointed day). That is, the transaction periods of the products 1, 2, and 3 for the electric power on the appointed day are on the previous day. For example, the transaction period of the product 1 on the appointed day is between 17:00 on the previous day and 23:00 on the previous day. On the other hand, the transaction periods of the products after the product 4 for the electric power on the appointed day extend over the days from the previous day to the appointed day. For example, the transaction period of the product 48 is between 17:00 on the previous day and 22:30 on the appointed day. The timing of processing is based on the timing of bidding, for example, the current time.

Returning to FIG. 1, the market information acquirer 100 acquires a transaction price history of each product in the market before the current time publicized by the power exchange 2 via, for example, a network. For example, if the current time is 18:00 on the appointed day, regarding the product 1, the market information acquirer 100 acquires the transaction history from 17:00 on the previous day to 23:00 on the previous day as price history information, and acquires the transaction history from 17:00 on the appointed day to 18:00 on the appointed day as price latest information. Regarding the product 48, the market information acquirer 100 acquires the transaction history from 17:00 on the previous day to 22:30 on the previous day as the price history information, and acquires the transaction history from 17:00 on the previous day to 18:00 on the appointed day as the price latest information.

The information acquired by the market information acquirer 100 is stored in the market information storage 110. The market information storage 110 includes a price history information storage 112 and a price latest information storage 114. The price history information storage 112 stores the price history information among the information acquired by the market information acquirer 100. The price latest information storage 114 stores the price latest information among the information acquired by the market information acquirer 100. As described above, regarding a product to be traded on the appointed day, the most recent history information on the price that has already closed is stored in the price history information storage 112, and the latest history information on the price that has not yet closed is stored in the price latest information storage 114. The market information storage 110 is provided in the bid-price determination apparatus 1 in FIG. 1, but is not limited to this, and may be provided in, for example, another server or the like via a network.

The product information feature quantity extractor 120 extracts a first feature quantity necessary for predicting a future bid price from the history information stored in the price history information storage 112. The first feature quantity is a feature quantity indicating a feature in the history information on a transaction of a product. The extracted first feature quantity is output to the market price predictor 130. As another example, the market information acquirer 100 may calculate the first feature quantity in advance from the acquired history information, and store it in the price history information storage 112. In this case, the product information feature quantity extractor 120 extracts the first feature quantity in the required period from the price history information storage 112.

The market price predictor 130 predicts, based on the first feature quantity extracted by the product information feature quantity extractor 120, a second feature quantity necessary for determining a transaction standard price (transaction standard value) to be a reference for predicting a bid price based using, for example, a prediction model. The second feature quantity is a feature quantity indicating a feature on future price changes of the product. The predicted second feature quantity is output to the transaction standard price determiner 140.

The prediction model to be used is, for example, a model generated by performing a regression analysis with the first feature quantity as an explanatory variable and the second feature quantity as a target variable using the past price history of the product in the continuous session. This regression model may be any model as long as it can appropriately predict the second feature quantity from the first feature quantity. For example, the regression model may be a linear model such as linear regression, or penalized regression (for example, ridge regression, or Lasso), a nonlinear model such as random forests or neural networks, or other models. As an estimation method, the least squares method or the Bayesian estimation can be appropriately selected according to the above model. As another example, dynamic fitting may be performed using a Kalman filter or the like.

As the past price history of the product used for generating the prediction model, the price history information for the past one month is used, for example. Regarding the price history information for the past one month, a model between the first feature quantity on the previous day and the second feature quantity on the appointed day is generated. The information for the past one month is merely an example, and a model for a period, such as the same month before a year ago, or the same season may be generated as another example. As still another example, using data for the past several years, a more heavily weighted model may be generated as the data comes closer to the appointed day of transaction. In this manner, it is possible to use a model that can appropriately predict the second feature quantity on the appointed day of transaction.

The transaction standard price determiner 140 determines, based on the second feature quantity predicted by the market price predictor 130, a transaction standard price (transaction standard value) that is a standard value of a bid price. The transaction standard price is a standard price to be compared with a price of the product at each timing when bidding is actually made. The determined transaction standard price is output to the market information monitor 150. The transformation from the second feature quantity to the transaction standard price may be a linear transformation or a non-linear transformation, and is set in advance by, for example, a simulation using past market information or the like. As another example, the transformation criterion may be set so as to be adjusted to be a value leaned to the safe side from the second feature quantity.

The market information monitor 150 monitors the latest price information stored in the price latest information storage 114, and compares the latest price of the product with the transaction standard price determined by the transaction standard price determiner 140 to determine whether each timing is suitable for bidding. This determination result is output to the output device 160.

The output device 160 perform output based on the determination result of the market information monitor 150 to the outside. The output device 160 includes, for example, a bidder and a display which are not shown. The bidder determines whether to bid at each timing based on the determination result of the market information monitor 150, and automatically bids a price based on the transaction standard price to the power exchange 2 via, for example, a network when determining that a timing is suitable for bidding. The display notifies the user of the transaction standard price or the like by displaying the transaction standard price or the like. Instead of the display, a printer for printing, a communicator for outputting necessary information by communication, a sound output device for outputting necessary information by sound, or the like may be provided.

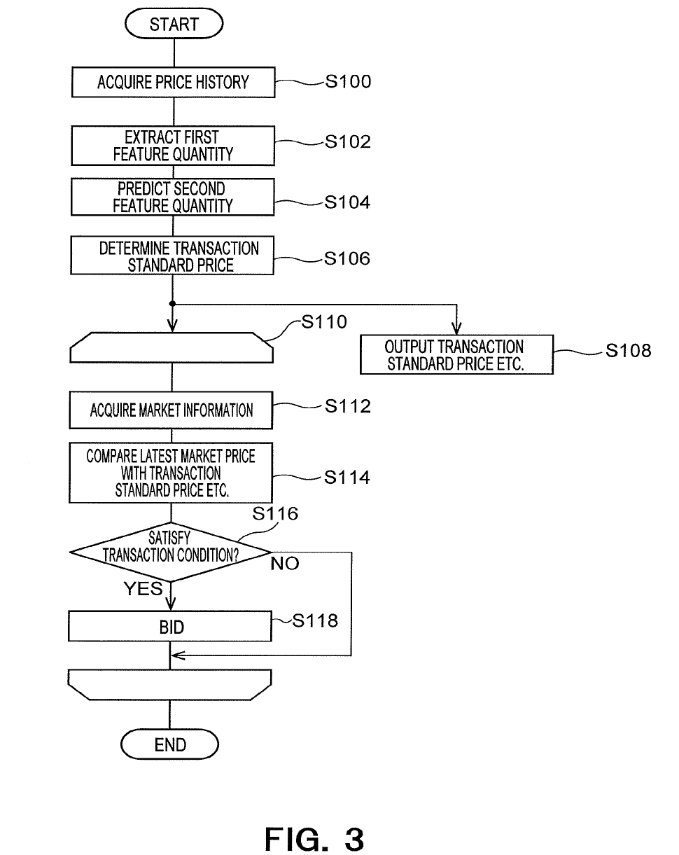

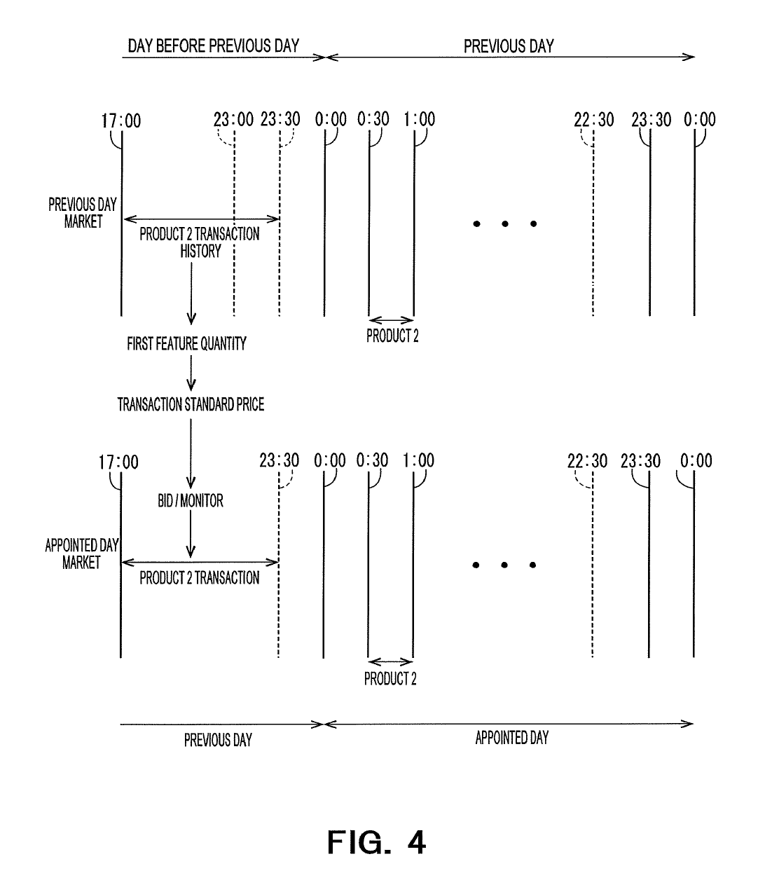

Next, a processing procedure of the above configuration, for example, a procedure of those who procure electric power until the bidding (buy order) on the product 2 will be described in more detail with reference to FIGS. 3 and 4. FIG. 3 is a flowchart showing a processing procedure of the bid-price determination apparatus 1 according to the present embodiment. FIG. 4 is a diagram showing a temporal procedure of the transaction of the product 2. Since the product 2 is sold and bought, it is assumed that the timings of all processing in the following description are between 17:00 and 23:30 on the previous day. In addition, a unit of the price is basically [yen/kWh], but is simply described as [yen]. Note that, a currency is not limited to yen, and a currency unit in each country can be used.

First, the market information acquirer 100 acquires the price history information on products publicized by the power exchange 2 (S100). Specifically, as shown in FIG. 4, the market information acquirer 100 acquires the transaction price history (price history information) from 17:00 on the day before the previous day to 23:30 on the day before the previous day which is the transaction period of the product 2 on the previous day, and the price history (price latest information) in the appointed-day market from 17:00 on the previous day to the timing when the market information acquirer 100 acquires the information.

The market information acquirer 100 is only required to acquire the price history information once after the previous-day market for the product is closed. For example, the market information acquirer 100 may acquire the available transaction histories on the previous day up to 17:00 on the previous day at the timing of 17:00 on the previous day, that is, all the transaction histories of the products 1 to 33 (or 34) on the previous day, and store the histories in the price history information storage 112. The market information acquirer 100 may acquire the other products when the price histories thereof become available. Alternatively, the market information acquirer 100 may acquire the history of each product at the timing when the market closes. Furthermore, the market information acquirer 100 may convert the information stored in the price latest information storage 114 into history information. It is preferable to acquire the price latest history at an appropriate timing.

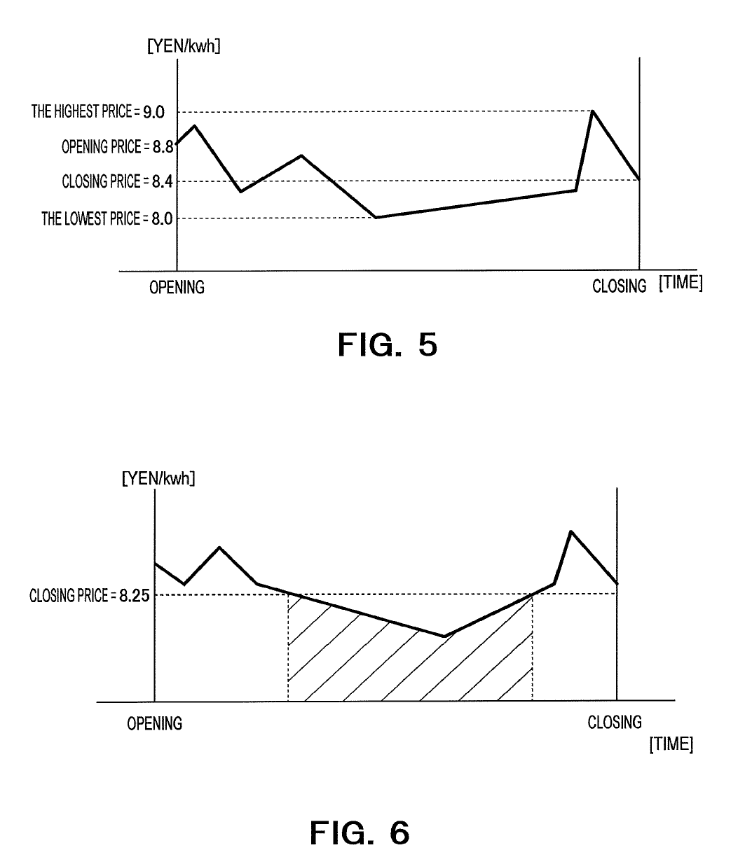

Next, the product information feature quantity extractor 120 extracts a first feature quantity from the price history of the product 2 stored in the price history information storage 112 (S102). For example, the product information feature quantity extractor 120 extracts the opening price, the highest price, the lowest price, and the closing price as the first feature quantity from the price history of the product 2 in the previous-day market. FIG. 5 is a diagram briefly showing price changes of a product in a market on a day. For example, in the case of the price changes as shown in FIG. 5, the product information feature quantity extractor 120 extracts, as the first feature quantity, 8.8 yen as the opening price, 9.0 yen as the highest price, 8.0 yen as the lowest price, and 8.4 yen as the closing price.

Next, the market price predictor 130 predicts a second feature quantity based on the extracted first feature quantity (S104). The second feature quantity is, for example, a feature quantity such as the highest price or the lowest price in the appointed-day market. The prediction of the second feature quantity is calculated using a prediction model with the first feature quantity as an explanatory variable. In the following description, it is assumed that, for example, the lowest price is the second feature quantity, and that the market price predictor 130 predicts the second feature quantity as to be 7.5 yen.

Next, the transaction standard price determiner 140 determines a transaction standard price based on the predicted second feature quantity (S106). The transaction standard price determiner 140 determines the transaction standard price by, for example, performing a linear transformation to the predicted second feature quantity. As an example of the linear transformation, the following expression may be used:

transaction standard price=a×second feature quantity+b More specifically, when it is assumed that a=1.1 and b=0.0, the transaction standard price is determined as 7.5×1.1+0.0=8.25 yen.

After the transaction standard price is determined, the transaction standard price may be displayed and output to the user via a display or the like provided to the output device 160 (S108). At least one of the first feature quantity and the second feature quantity may be displayed together with the transaction standard price. Furthermore, when the first feature quantity is output, that the first feature quantity is based on which data in the past may be also output.

By performing output in this manner, it is possible for the user to recognize that the transaction standard price is determined using which feature quantity in the history information at which point in the past. It is also possible for the user to confirm whether the transaction standard price and the feature quantity used for determining the transaction standard price are appropriate. If the user considers that the result is inappropriate, the user may manually set parameters or the like. Here, the user may be, for example, a person who buys electric power or a person who supplies electric power.

In the case of performing display as described above, the product information feature quantity extractor 120, the market price predictor 130, and the transaction standard price determiner 140 may directly notify the output device 160 of the extracted first feature quantity, the predicted second feature quantity, and the determined transaction standard price respectively. In this manner, it is possible for the user to acquire the transaction standard price of the desired product in real time and the information on the first feature quantity and the second feature quantity used for the determination.

Further, not only the second feature quantity such as the lowest price but also other state quantities in the appointed-day market may be displayed. For example, not only the information on the lowest price in the appointed-day market but also the predicted highest price or a predicted closing price may be outputted. As described above, it is possible to output other state quantities necessary for predicting transactions.

Furthermore, the used prediction model of the second feature quantity, a correction expression (correction model) of the transaction standard price, and the like may be displayed. By performing output in this manner, it is possible for the user to recognize that the transaction standard price is determined based on which model.

On the other hand, the output device 160 may bid to the power exchange 2 using the determined transaction standard value. In this case, the output device 160 automatically bids based on the determined transaction standard price and the current bid price of the product by loop processing (S110). This loop processing is repeated until, for example, at the timing when the required amount of electric power can be secured, or when the continuous session is closed.

When bidding is to be made, first, the market information monitor 150 acquires the latest transaction price of the product stored in the price latest information storage 114 (S112). In this case, the market information monitor 150 may not only read the information stored in the price latest information storage 114, but also acquire the information from the power exchange 2 via the market information acquirer 100 at a necessary timing. In this case, the price latest information storage 114 is not an essential configuration.

Next, the market information monitor 150 compares the determined transaction standard price with the latest transaction price of the product (S114), and determines whether the product satisfies the transaction condition at the timing (S116). Satisfying the transaction condition is, for example, when the latest transaction price is lower than the transaction standard price in the case where the user intends to procure the product 2.

Note that, the present invention is not limited to this, and the transaction standard price may be corrected based on the current timing and the closing timing in the continuous session. For example, if the remaining time to close is short, the transaction condition may be adjusted so as to be determined to be suitable for transaction (buying) although the latest transaction price is slightly higher than the transaction standard price. As another example, the transaction standard price may be dynamically changed based on the remaining time to close.

In the change to the transaction standard price or the adjustment of the transaction standard price itself, the transaction standard price from the opening to closing of the market may be adjusted using a vertically bounded function such as the sigmoid function or the arctangent function, or the transaction standard price may be adjusted so as to increase linearly. However, the present invention is not limited to these, and the transaction standard price may be adjusted linearly or nonlinearly. Furthermore, the price may be adjusted not only based on the timing of the opening and closing of the market but also based on the required amount of electric power to be procured at the timing and the amount of electric power already procured at the timing.

When the market price at the timing satisfies the transaction condition (S116: YES), the output device 160 bids to the power exchange 2. For example, if the acquired lowest price of the product 2 in the latest price information is lower than the transaction standard price of 8.25 yen, a buy order is made. Orders may be made with a transaction market price as a limit price or at a market order.

As a result of the bidding, when the procured electric power has not reached the required amount, and when the transaction condition is not satisfied (S116: NO), the processing in S112 to S118 is repeated. On the other hand, when the required amount of electric power has been procured, the processing exits from the loop from S110 to S118 and is terminated.

Bidding may be made by repeating the loop a plurality of times for a predetermined amount of electric power until the procured amount of the electric power reaches the required amount, made once for the required amount of electric power, or made with the transaction standard price as a limited price at the timing when the transaction standard price is determined without the loop processing. When bidding is made at a limit price at the timing when the transaction standard price is determined, the market information monitor 150 is not an essential configuration. As described above, the timing of bidding and the amount of electric power are not limited to these as long as setting has been performed so that the required amount of electric power is appropriately procured.

FIG. 6 is a diagram showing an example of price changes of a product in an electric power continuous session. In the case where the appointed-day market changes as shown in FIG. 6, the output device 160 automatically bids at the timing when the market price becomes lower than the transaction standard price of 8.25 yen (the period indicated by hatching). As described above, the timing of bidding and the amount of bidding may be determined in any way. However, when, for example, bidding is made a plurality of times for a predetermined amount, bidding may be made at predetermined time intervals. In this manner, in the case of, for example, the price changes as shown in FIG. 6, bidding is made at a price lower than 8.25 yen, and the possibility of bidding at a further lower price increases.

As described above, according to the present embodiment, by making bidding at the standard price predicted based on the history information of the product in the past (for example, the previous day) in the electric power continuous session, it is possible to procure electric power at a price close to the expected lowest price when procuring electric power in the electric power continuous session. In other words, it is possible to algorithmic trade at an appropriate price in a continuous session where it is difficult to generate a portfolio.

(First Modification)

In the above description, the procurement of electric power has been described, but it is also possible to bid for selling electric power similarly. In the case of selling electric power, for example, the highest price is predicted as the second feature quantity using a regression model, and the transaction standard price is determined using a linear model such as 0.9×second feature quantity+0.0 [yen].

In the situation described above, when the user is a person who sells electric power, the second feature quantity is predicted as, for example, 9.5 yen, and in this case, the transaction standard price is 0.9×9.5+0.0=8.55 [yen]. Then, the bid-price determination apparatus 1 can automatically bid for selling electric power at a price equal to or higher than 8.55 yen, or higher than 8.55 yen using the transaction standard price. Naturally, the transaction standard price is not limited to 8.55 yen, and the transaction standard price may be dynamically changed by dynamically estimating the second feature quantity or correcting the transaction standard price as described above.

As described above, it is possible to use the bid-price determination apparatus 1 according to the present embodiment not only when procuring electric power but also when selling electric power in a continuous session.

(Second Modification)

The price history information and the price latest information are not limited to those described above. For example, information which is price history information in an un-closed market but is not the latest may be transferred from the price latest information storage 114 to the price history information storage 112 to be stored. In this manner, it is possible to reflect the price history in the un-closed appointed-day market in the determination of the transaction standard price. In this case, the first feature quantity may be the highest price, the lowest price, and the like extracted from, for example, the price history in the closed previous-day market and the price history in the un-closed appointed-day market. When the price history in the appointed-day market is used as described above, the transaction standard price may be updated at the timing when the first feature quantity is changed.

Especially, as the product number becomes larger, the transaction period in the appointed-day continuous session becomes longer, and the importance of the information on the transactions already made in the appointed-day market increases in addition to the transactions in the continuous sessions until the previous day. In this case, by reflecting the transaction history in the un-closed appointed-day continuous session in the prediction of the second feature quantity and the determination of the transaction standard price, it is possible to improve the accuracy of determination of the bid price at the timing of procurement. In the case of reflecting the appointed-day market information in the prediction and the determination, a prediction model of the second feature quantity and a correction model of the transaction standard price may be different from the case of using the information until the previous day, or the prediction and the determination may be calculated by a dynamic model similarly as described above.

(Third Modification)

The first feature quantity is not limited to the four values of the opening price, the highest price, the lowest price, and the closing price, and may be other statistical quantity such as the average value, the variance value, the standard deviation value, the median value, or the mode value, in the price changes of the previous-day market. In this case, by appropriately setting the explanatory variables in the regression model correspondingly to the extracted first feature quantity, it is possible to predict the second feature quantity. For example, the second feature quantity may be predicted using three values of the average value, the variance value, and the median value as explanatory variables. As another example, by taking the average value and the variance value of the price into consideration in addition to the four values, the second feature quantity may be calculated using these six values as explanatory variables.

(Fourth Modification)

The bid-price determination apparatus 1 may include an environmental information acquirer (not shown), and acquire the temperature and weather of the appointed day. A model may be generated using the acquired temperature and weather together with the first feature quantity as an explanatory variable for predicting the second feature quantity. The environmental information may be used not only for a prediction model of a second feature quantity but also for correction when the transaction standard price is calculated from the second feature quantity. In this case, a correction model including, in addition to past market information, information on past temperature and weather may be generated.

(Fifth Modification)

The model for predicting the second feature quantity may be generated using the first feature quantity of the products preceding and following the product. For example, when the second feature quantity of the product 2 is predicted, the first feature quantities of the product 1 and the product 3, in addition to the first feature quantity of the product 2, may also be inputted as explanatory variables. In this case, in the model, the first feature quantity of the product 2 may be weighted more than the first feature quantities of the product 1 and the product 3. Furthermore, the first feature quantities to be inputted may be widely extracted from not only the products 1 and 3 but also from the product 4 and the most recent product 48, and the like. In this case, weighting for each product at the time of predicting the second feature quantity may be changed.

(Sixth Modification)

In the above-described embodiment and modifications, it has been exemplified that the transaction standard price determiner 140 determines the transaction standard price by linearly or non-linearly correcting the second feature quantity, but the transaction standard price determiner 140 may correct the second feature quantity as a nonparametric distribution.

The case of procuring the product 2 will be described. For example, based on the assumption that the second feature quantity is the average value (average execution price) and is estimated to be 8.5 yen. The transaction standard price determiner 140 may regard the average value as the median value in advance by simulation or analysis using past market information, and generate a model in which the 20th percentile value from this average value is determined as the transaction standard price. Alternatively, by predicting the second feature quantity as the median value, the 20th percentile value may be determined as the transaction standard price. Specifically, for example, the distribution of the transaction price of the product 2 is acquired from the market information until the previous day. The price relation of the 20th percentile from the median value of the past market prices is calculated based on the distribution information, and the transaction standard price is determined based on this relation. This relation may be expressed using a function. This function may be linear or nonlinear. As an example, the relation can be functionalized as a linear model representing the ratio of the median value in the distribution information until the previous day and the 20th percentile value.

For example, when 8.5 yen is substituted in the obtained function and 8.25 yen is output, the transaction standard price is determined to be 8.25 yen. By using this transaction standard price, it is possible to make efficient algorithmic trading similarly to the above embodiment and modifications. Furthermore, by setting the transaction standard price as the 80th percentile value of the average value, it is possible to determine the transaction standard price close to the highest price, and to use this transaction standard price in the case of selling electric power.

(Seventh Modification)

The above bid-price determination apparatus 1 does not particularly receive input by the user, and determines the transaction standard price using the processing method and parameter set to the apparatus in advance, but is not limited thereto. That is, the user may refer to the transaction standard price or the like output from the output device 160 and correct the transaction standard value.

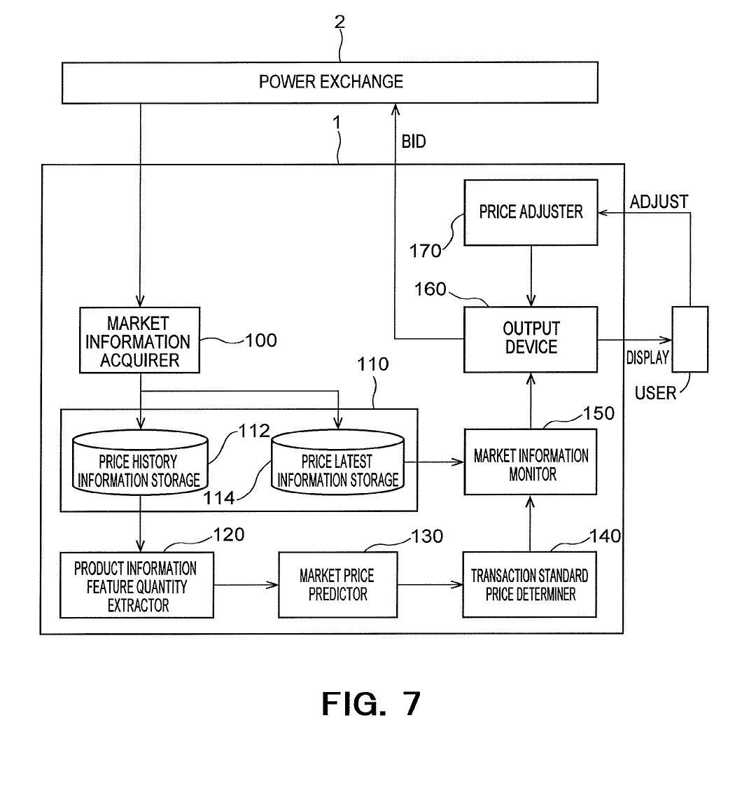

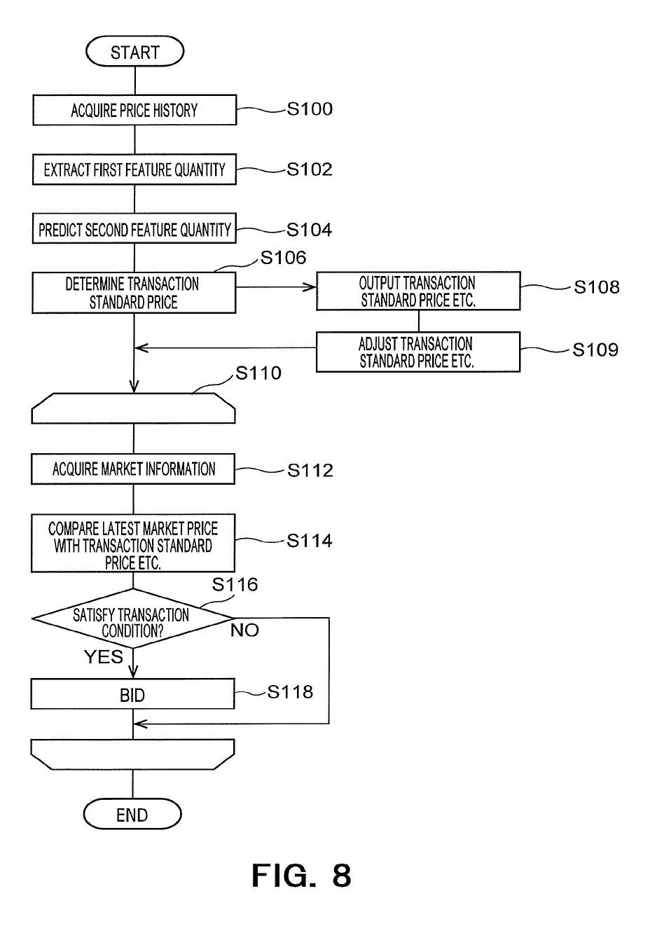

FIG. 7 is a diagram showing the bid-price determination apparatus 1 according to the present modification. The bid-price determination apparatus 1 according to the present modification further includes a price adjuster 170 in addition to the configuration of the bid-price determination apparatus 1 according to the above embodiment and modifications. FIG. 8 is a flowchart showing a processing procedure according to the present modification.

When desiring to manually adjust the transaction standard price output by the output device 160, the user adjusts the transaction standard price with the price adjuster 170 via an input interface (not shown). The price adjuster 170 receives input from the user and adjusts the transaction standard price (S109). Thereafter, the price adjuster 170 notifies the output device 160 of the adjusted transaction standard price. When receiving the notification, the output device 160 automatically makes subsequent bidding using the adjusted transaction standard price.

As described above, by further including the price adjuster 170, it is possible for the user to adjust the output transaction standard value. In this manner, it is possible to efficiently make algorithmic trading and to set a price satisfying the user. In addition, when the user desires to set the transaction standard price from the beginning, it is possible for the bid-price determination apparatus 1 to present a standard value based on the past price history or the like of the product that the user desires to trade, and thereby to omit the user's time and effort.

The value to be adjusted by the user is not limited to the transaction standard price. For example, when the output device 160 outputs the second feature quantity, the user may adjust the output second feature quantity. Then, the price adjuster 170 may determine the transaction standard price using the second feature quantity adjusted by the user, and the output device 160 may bid based on the adjusted transaction standard price determined by the price adjuster 170.

(Eighth Modification)

In the seventh modification described above, the price adjuster 170 is provided in order for the user to refer to the output transaction standard value or the like and to adjust the transaction standard price or the like, but the price adjustment method is not limited thereto.

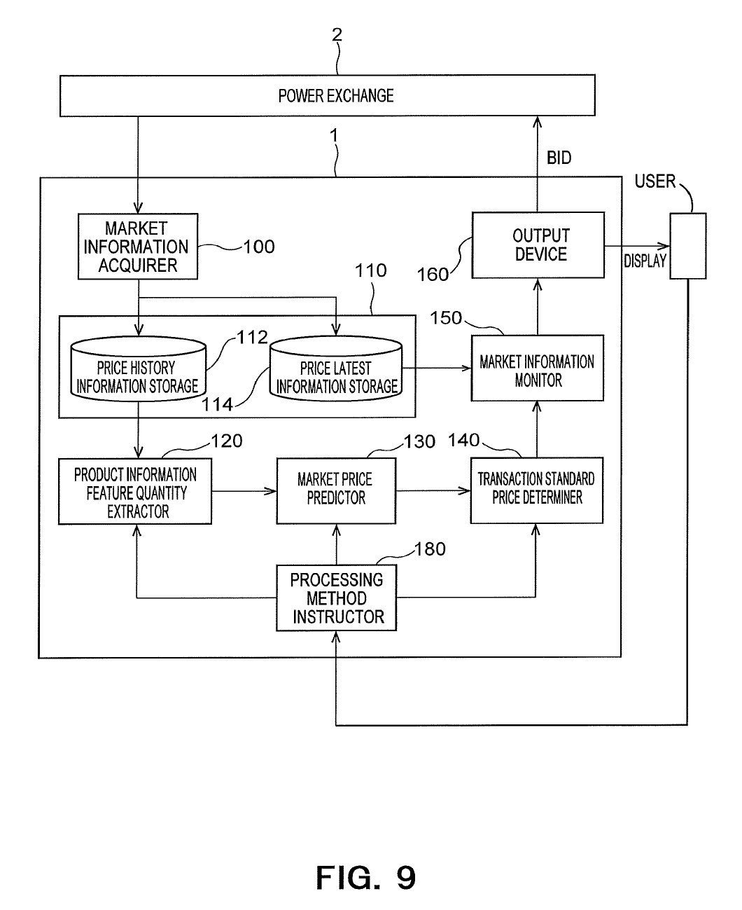

FIG. 9 is a block diagram showing functions of the bid-price determination apparatus 1 according to the present modification. The bid-price determination apparatus 1 further includes a processing method instructor 180. For example, the processing method instructor 180 allows the user to instruct the extraction method in order for the product information feature quantity extractor 120 to extract the first feature quantity. For example, similarly to the above embodiment, the product information feature quantity extractor 120 extracts the opening price, the highest price, the lowest price, and the closing price of the previous-day market as the first feature quantity.

When desiring to change the feature quantity to be extracted as the first feature quantity, the user performs input to the processing method instructor 180 so as to extract four feature quantities of, for example, the average value, the variance value, the median value, and the mode value as the first feature quantity. In response to the input, the processing method instructor 180 instructs the product information feature quantity extractor 120 to extract the four feature quantities of the average value, the variance value, the median value, and the mode value as the first feature quantity. After receiving the instruction, the product information feature quantity extractor 120 shifts to the processing for extracting the new four feature quantities as the first feature quantity. Thereafter, the second feature quantity is predicted based on the first feature quantity, and then the transaction standard price is determined.

As described above, according to the present modification, it is possible for the user to instruct the processing method at each stage, and to determine an appropriate bid price reflecting the intention of the user.

The processing method instructor 180 does not necessarily perform instruction only to the product information feature quantity extractor 120. In other words, the processing method instructor 180 may instruct the market price predictor 130 to predict the second feature quantity from the first feature quantity using a prediction method (a prediction model or the like), and instruct the transaction standard price determiner 140 to determine the transaction standard price from the second feature quantity using a determination method (a correction model or the like).

(Ninth Modification)

In the embodiment and the modifications described above, it has been exemplified that the bid-price determination apparatus 1 determines the transaction standard price based on the history of the transaction price in the electric power continuous session. However, as explanatory variables, not only the price in the electric power continuous session but also transaction information in the electric power spot market can also be used.

That is, the market information acquirer 100 acquires not only the transaction history in the electric power continuous session but also the information on the transaction history in the electric power spot market. For example, the market information acquirer 100 acquires the transaction price in the previous-day spot market which is the transaction period of product 2 on the appointed day. Specifically, the market information acquirer 100 acquires the information on the execution price, the execution amount, the selling bid amount, the buying bid amount, and the like of the product 2 in the previous-day spot market.

The product information feature quantity extractor 120 extracts, in addition to the information on the previous day electric power continuous session such as the opening price, the highest price, the lowest price, and the closing price, the information on the previous-day spot market such as the execution price and the execution amount as the first feature quantity. In this case, the information on the spot market may be directly used as the first feature quantity or may be processed as the first feature quantity. The subsequent processing is performed similarly to the above embodiment or modifications. That is, by using the extracted first feature quantity as an explanatory variable, and predicting the second feature quantity which is a target variable, the transaction standard price is determined from the predicted second feature quantity.

As described above, according to the present modification, by acquiring not only the information on the continuous session but also the information on the spot market, it is possible to predict the highest price or the lowest price in the appointed-day continuous session more accurately. In this manner, by increasing the accuracy, it is possible to make more efficient algorithmic trading than the above embodiment and modifications.

In order to further improve the accuracy as in the above modification, the information on the products preceding and following the product 2 (products 1 and 3, or the like) in the spot market or the information on the spot market before the previous day may be acquired.

In all the examples described above, the numbers indicated as magic numbers are merely examples, and the embodiment and modifications are not limited thereto. For example, the coefficient of 1.1 and 20th percentile value used for the explanation in the correction model are not limited to these values.

All of the embodiments described above are carried out through a hardware (including circuitry) configuration, for example. Specifically, the bid-price determination apparatus 1 is constructed in a computer, and the bid-price determination apparatus 1 receives instructions from a user by using a mouse and a keyboard as interfaces. In a hard disk, a program which activates the computer and activates the bid-price determination apparatus 1 may be included, and a database which stores and holds input/output data of the bid-price determination apparatus 1 may be constructed. A display is provided as a visual interface of the bid-price determination apparatus 1. Servers are various databases such as the price history information storage 112, for example, and further, it is also possible to provide tools for obtaining desired data from these databases. As another example, the various databases may also be constructed in the hard disk connected to the computer.

At least a part of the device and the system described in the aforementioned embodiments may also be configured by hardware or software. When configuring the above using the software, it is also possible to design such that a program realizing at least a part of functions of the device and the system is housed in a recording medium such as a flexible disk or a CD-ROM, and a computer is made to read and execute the program. A storage medium is not limited to a detachable one such as a magnetic disk or an optical disk, and it may also be a fixed-type storage medium such as a hard disk device or a memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A bid-price determination apparatus comprising:
an acquirer configured to acquire a price history of a product before a current time in an electric power continuous session;
an extractor configured to extract, from the acquired price history, a first feature quantity which is a feature quantity of the price history of the product;
a predictor configured to predict, based on the extracted first feature quantity, a second feature quantity which is a feature quantity of price changes of the product after the current time;
a determiner configured to determine, based on the predicted second feature quantity, a transaction standard value which is a standard for a transaction of the product after the current time; and
an output device configured to output the determined transaction standard value.

2. The bid-price determination apparatus according to claim 1, wherein the extractor extracts, as the first feature quantity, an opening price, the highest price, the lowest price, and a closing price in a predetermined period in the price history of the product.

3. The bid-price determination apparatus according to claim 1, wherein the predictor predicts, based on the first feature quantity of the product extracted by the extractor, the highest price or the lowest price of the product as the second feature quantity.

4. The bid-price determination apparatus according to claim 1, wherein the predictor predicts, based on the first feature quantity of the product extracted by the extractor, an average execution price of the product as the second feature quantity.

5. The bid-price determination apparatus according to claim 1, wherein the determiner determines the transaction standard value by performing a linear transformation to the second feature quantity predicted by the predictor.

6. The bid-price determination apparatus according to claim 1, wherein the determiner determines the transaction standard value by performing a nonlinear transformation to the second feature quantity predicted by the predictor.

7. The bid-price determination apparatus according to claim 1, wherein the output device comprises a display configured to display at least one of the second feature quantity predicted by the predictor and the transaction standard value determined by the determiner as numerical data.

8. The bid-price determination apparatus according to claim 7 further comprising:
an adjuster configured to accept input from a user and adjust the second feature quantity or the transaction standard value, wherein
the display displays at least one of the second feature quantity and the transaction standard value as numerical data to the user, and then the adjuster adjusts the second feature quantity or the transaction standard value according to input from the user, and
the output device outputs a transaction standard value adjusted by the adjuster.

9. The bid-price determination apparatus according to claim 1, wherein the output device comprises a bidder configured to bid, based on the transaction standard value determined by the determiner, on the product in the electric power continuous session.

10. The bid-price determination apparatus according to claim 9 further comprising:
a monitor configured to monitor a price of the product in the electric power continuous session, wherein
the bidder compares the transaction standard value determined by the determiner with the price monitored by the monitor, and bids based on a comparison result.

11. The bid-price determination apparatus according to claim 10, wherein the bidder automatically bids based on the comparison result.

12. The bid-price determination apparatus according to claim 1, further comprising an instructor configured to accept, from a user, a processing method used until the transaction standard value is determined and performs an instruction for performing processing by the processing method.

13. The bid-price determination apparatus according to claim 12, wherein
the instructor accepts an extraction method of the first feature quantity as the processing method, and instructs the extractor to extract the first feature quantity from the price history using the accepted extraction method of the first feature quantity, and
the extractor extracts the first feature quantity based on the extraction method.

14. The bid-price determination apparatus according to claim 12, wherein
the instructor accepts a prediction method of the second feature quantity as the processing method, and instructs the predictor to predict the second feature quantity from the first feature quantity using the accepted prediction method of the second feature quantity, and
the predictor predicts the second feature quantity from the first feature quantity based on the prediction method.

15. The bid-price determination apparatus according to claim 12, wherein
the instructor accepts a determination method of the transaction standard value as the processing method, and instructs the determiner to determine the transaction standard value from the second feature quantity using the accepted determination method of the transaction standard value, and
the determiner determines the transaction standard value from the second feature quantity based on the determination method.

16. A bid-price determination method comprising:
acquiring, by an acquirer, a price history of a product before a current time in an electric power continuous session;
extracting, by an extractor, a first feature quantity which is a feature quantity of the price history of the product from the acquired price history;
predicting, by a predictor, a second feature quantity which is a feature quantity of price changes of the product after the current time based on the extracted first feature quantity;
determining, by a determiner, a transaction standard value which is a standard for a transaction of the product after the current time based on the predicted second feature quantity; and
outputting, by an output device, the determined transaction standard value.

17. A non-transitory computer readable medium recording a program causing a computer to function as:
an acquirer configured to acquire a price history of a product before a current time in an electric power continuous session;
an extractor configured to extract, from the acquired price history, a first feature quantity which is a feature quantity of the price history of the product;
a predictor configured to predict, based on the extracted first feature quantity, a second feature quantity which is a feature quantity of price changes of the product after the current time;
a determiner configured to determine, based on the predicted second feature quantity, a transaction standard value which is a standard for a transaction of the product after the current time; and
an output device configured to output the determined transaction standard value.
